(19) United States
(12) Patent Application Publication
(10) Pub. No.: US 2006/0244366 A1
(43) Pub. Date: Nov. 2, 2006

(54) Blue excited yellow fluorescent material and white light emitting element using the same

(75) Inventors: Asuka Sasakura, Ageo-shi (JP); Tomoyasu Yano, Ageo-shi (JP); Jun-ichi Itoh, Ageo-shi (JP)

Correspondence Address: ROTHWELL, FIGG, ERNST & MANBECK, P.C., 1425 K STREET, N.W., SUITE 800, WASHINGTON, DC, 20005, US

(73) Assignee: MITSUI MINING & SMELTING CO., LTD., Tokyo (JP)

(21) Appl. No.: 11/412,141

(22) Filed: Apr. 27, 2006

(30) Foreign Application Priority Data
Apr. 28, 2005 (JP) JP2005-133465

(51) Int. Cl. H01J 1/62

(52) U.S. Cl. 313/503

(57) ABSTRACT

There is provided a blue excited yellow fluorescent material that shows a broad light emitting spectrum ranging from green components to red components, is easy to control color tones, has high color rendering properties, and can provide white light close to natural light (sunlight), by combining with a blue light emitting element such as LED. To achieve the above features, a blue excited yellow fluorescent materials comprising an alkaline earth metal sulfide as a crystal base material, the fluorescent material activated by Ce³⁺ and Eu²⁺ or Mn²⁺ is used; and specifically, a blue excited yellow fluorescent material represented by (Ca₁₋ₓSrₓ)S:Ce, Eu or (Ca₁₋ₓSrₓ)S:Ce, Mn is preferably used.

### BACKGROUND OF THE INVENTION

1. Field of the Invention

The present invention relates to a blue excited yellow fluorescent material containing an alkaline earth metal sulfide as a main component, and a white light emitting element using the same. Specifically, the present invention relates to a blue excited yellow fluorescent material containing an alkaline earth metal sulfide as a main component from which white light close to natural light can be obtained by combining with a blue light emitting element.

2. Description of the Related Art

Heretofore, fluorescent lamps or incandescent lamps have been used as white light sources. However, these white light sources have problems in aspects of electric power consumption, size, operation life and the like.

Since a light emitting diode (LED) is small and efficient, and can emit clear color light, demand as a light emitting element is expected. In addition, since a light emitting diode is a solid element, it has characteristics, such as long operation life, favorable initial drive performance, excellent vibration resistance, and resistance to repetitive on-off blinking. Therefore, a light emitting diode is widely used as light emitting element in various indicators or various light sources that consume little electric power.

In recent years, ultra-high-intensity, high-efficiency red, green and blue light emitting diodes have been developed, and large-screen LED displays using these light emitting diodes as light emitting elements have been used. These LED displays can be operated by small electric power, and have advantages of light weight and long life. Under such situations, the appearance of a white color emitting device using a light emitting diode as a light emitting element as an alternative of fluorescent lamps or incandescent lamps is expected.

However, when a light emitting diode is used as a light emitting element, there is a problem in that the light emitting diode has generally a light emitting spectrum having strong monochromaticity, and has no broad light emitting spectrum in the visible light region required for obtaining white light.

Recently, therefore, there has been an attempt to generate white light by installing light emitting elements, such as light emitting diodes, to provide three components of light, red, green and blue, so as to come close to each other, making these emit light, and diffusing and mixing the light to generate white light, and such a product has already been used as a large screen LED display.

In this method, however, since the temperature characteristics and change in performance with time of individual diodes are different, there are problems such as that color tone and luminescence of each of red, green and blue color emitting vary, emitted lights cannot be evenly mixed, and color irregularity occurs; therefore, a desired white light cannot be obtained. In addition, since the materials for each light emitting diode are generally different, and driving powers are different, a predetermined voltage must be applied to each light emitting diode; therefore, there is a problem in that the driving circuit becomes complicated.

As another method to obtain white light, there has been proposed a method to obtain white light, wherein light emitted from a light emitting element, such as a light emitting diode, is absorbed by a fluorescent material, the absorbed light is converted into a light having a different wavelength, and the light emitted from the light emitting diode is diffused into and mixed with the light having a wavelength changed by the fluorescent material.

In Patent Document 1 (Japanese Patent No. 3503139), a light emitting device wherein gallium nitride-based semiconductor containing In is used as a light emitting diode (light emitting element), and cerium-activated garnet (Y₃Al₅O₁₂:Ce and the like) is used as a fluorescent material is described.

This light emitting device is an LED chip that can emit blue light, wherein the light emitting element is a gallium nitride-based semiconductor containing In as described above having a light emitting peak in a wavelength range between 420 and 490 nm. Cerium-activated garnet fluorescent material (Y₃Al₅O₁₂:Ce and the like) is used as the fluorescent material, which absorbs a part of the spectrum of the above-described blue light emitting, and has a light emitting peak in a vicinity of wavelength range between 510 and 600 nm. FIG. 7 shows the light emitting spectrum of an In-containing gallium nitride-based semiconductor (blue light emitting diode) and cerium-activated garnet fluorescent material (Y₃Al₅O₁₂:Ce)

Since a white light emitting device formed by combining the cerium-activated garnet fluorescent material (YAG:Ce or the like) with a blue LED consumes little electric power and contains no toxic mercury as compared with fluorescent lamps, it is expected as a new type of white illumination that takes into account the reduction of environmental burden.

However, since this cerium-activated garnet fluorescent material has the peak of the light emitting spectrum in the vicinity of wavelengths between 510 and 600 nm, it has little red component of wavelengths between 580 and 650 nm, color rendering properties are poor, and objects illuminated by the light emitting device show unnatural colors; therefore, the application to general illumination has problems. Meanwhile, the wavelengths of the blue component are about 400 to 480 nm; and the wavelengths of the green component are about 480 to 560 nm.

On the other hand, in Patent Document 2 (Japanese Patent Application Laid-Open No. 2005-20010), a light emitting device consisting of a blue LED, a green fluorescent material composition, and a red fluorescent material composition is described. The light emitting device receives light emitted from the blue LED (blue light) with the green fluorescent material composition and the red fluorescent material composition, and emits long-wavelength light (green light and red light), to obtain white light by the diffusion color mixing with the blue light from the blue LED, and green light and blue light from the fluorescent material compositions.

However, since the light emitting device uses a plurality of fluorescent materials (compositions), color control is difficult due to the interaction of the fluorescent materials.

[Patent Document 1] Japanese Patent No. 3503139

[Patent Document 2] Japanese Patent Laid-Open No. 2005-20010

Heretofore, as described above, fluorescent materials that show a broad light emitting spectrum ranging from green components to red components by absorbing light emitted from blue LED, are easy to control colors, have high color rendering properties, and provide white light close to natural light (sunlight) have not been obtained.

### SUMMARY OF THE INVENTION

Therefore, it is an object of the present invention to provide a blue excited yellow fluorescent material that shows broad light emitting spectrum containing from green components to red components, is easy to control colors, has high color rendering properties, and can obtain white light close to natural light (sunlight), by combining with a blue light emitting element such as LED.

As a result of extensive studies to achieve the above object, the present inventors have found that the object can be achieved by a yellow fluorescent material comprising an alkaline earth metal sulfide as a crystal base material, and Ce³⁺ and Eu²⁺ or Mn²⁺ as a light emitting center.

Specifically, the present invention provides a blue excited yellow fluorescent material comprising an alkaline earth metal sulfide as a crystal base material, the fluorescent material activated by Ce³⁺ and Eu²⁺.

The blue excited yellow fluorescent material according to the present invention is preferably represented by the following general formula (1):
(Ca₁₋ₓSrₓ)S:Ce, Eu (1)
wherein 0≦x≦1.

In the blue excited yellow fluorescent material according to the present invention, the concentration of Ce³⁺ and Eu²⁺ is preferably 0.005 to 10 mol % based on the crystal base material.

The present invention also provides a blue excited yellow fluorescent material comprising an alkaline earth metal sulfide as a crystal base material, the fluorescent material is activated by Ce³⁺ and Mn²⁺.

The blue excited yellow fluorescent material according to the present invention is preferably represented by the following general formula (2):
(Ca₁₋ₓSrₓ)S:Ce, Mn (2)
wherein 0≦x≦1.

In the blue excited yellow fluorescent material according to the present invention, the concentration of Ce³⁺ and Mn²⁺ is preferably 0.005 to 10 mol % based on the crystal base material.

The present invention also provides a white light emitting element comprising a blue light emitting diode and a blue excited yellow fluorescent material according to the present invention, and using the blue light emitting diode as an excitation light source for the blue excited yellow fluorescent material.

The blue excited yellow fluorescent material according to the present invention generates yellow light by blue light excitation, and shows a broad white light emitting spectrum over a range between 420 and 680 nm by combining blue light of the excitation light. Since the blue excited yellow fluorescent material uses an alkaline earth metal sulfide as the crystal base material, it excels in reliability and resistance to environment. Therefore, the blue excited yellow fluorescent material according to the present invention can be applied to general illumination that requires white light close to natural light (sunlight). The blue excited yellow fluorescent material according to the present invention can also be expected as the backlight for liquid crystals and the fluorescent material for ELs, FEDs, or CRTs in the field of display devices.

### BRIEF DESCRIPTION OF THE DRAWINGS

FIG. 1 is a graph showing an absorption (excitation) spectrum of Example 1;

FIG. 2 is a graph showing a fluorescence spectrum (excitation wavelength: 470 nm) of Example 1;

FIG. 3 is a graph showing fluorescence spectra (excitation wavelength: 460 nm) of Example 2;

FIG. 4 is a graph showing a fluorescence spectrum (excitation wavelength: 430 nm) of Example 3;

FIG. 5 is a graph showing fluorescence spectra (excitation wavelength: 430 nm) of Example 4;

FIG. 6 is a graph showing fluorescence spectra (excitation wavelength: 430 nm) of Example 5; and

FIG. 7 is a graph showing a fluorescence spectrum of a gallium nitride-based semiconductor (blue light emitting diode) and cerium-activated garnet (Y₃Al₅O₁₂:Ce).

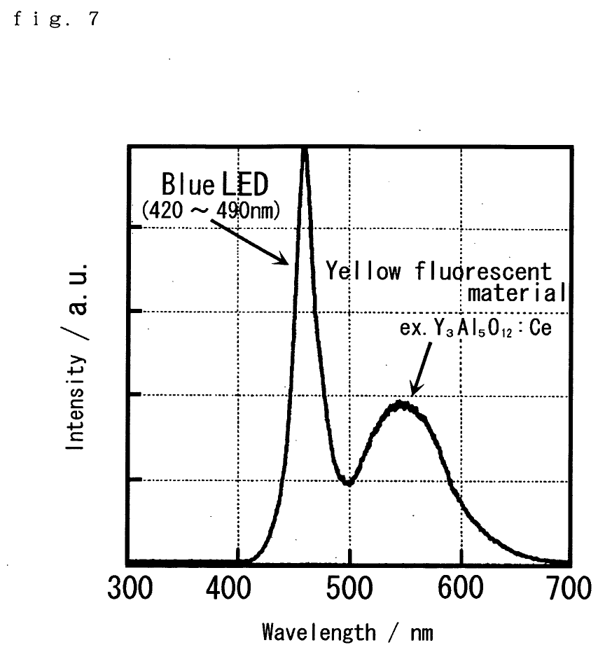

### DETAILED DESCRIPTION OF THE PREFERRED EMBODIMENTS

The preferred embodiments to carry out the present invention will be described below.

(Blue Excited Yellow Fluorescent Material According to the Present Invention A)

The blue excited yellow fluorescent material according to the present invention A is a fluorescent material of a halite structure wherein an alkaline earth metal sulfide is used as a crystal base material, and Ce³⁺ and Eu²⁺ are used as a light emitting center.

Since (Ca₁₋ₓSrₓ)S (wherein 0≦x≦1) is preferably used as the alkaline earth metal sulfide, the blue excited yellow fluorescent material represented by the following general formula (1) is preferred:
(Ca₁₋ₓSrₓ)S:Ce, Eu (1)
wherein 0≦x≦1.

In the blue excited yellow fluorescent material according to the present invention A, the concentration of each of Ce³⁺ and Eu²⁺, which are light emitting centers, is preferably 0.005 to 10 mol %, and more preferably 0.01 to 2 mol %, to the crystal base material. If the concentration is less than 0.005 mol %, the effect of containing these components cannot be obtained; and if the concentration exceeds 10 mol %, out-of-phase components precipitate, and the luminance lowers markedly.

(Blue Excited Yellow Fluorescent Material According to the Present Invention B)

The blue excited yellow fluorescent material according to the present invention B is a fluorescent material of a halite structure wherein an alkaline earth metal sulfide is used as a crystal base material, and Ce³⁺ and Mn²⁺ are used as a light emitting center.

Since (Ca₁₋ₓSrₓ)S (where 0≦x≦1) is preferably used as the alkaline earth metal sulfide, the blue excited yellow fluorescent material represented by the following general formula (2) is preferred:
(Ca₁₋ₓSrₓ)S:Ce, Mn (2)
wherein 0≦x≦1.

In the blue excited yellow fluorescent material according to the present invention B, the concentration of each of Ce³⁺ and Mn²⁺, which are light emitting centers, is preferably 0.005 to 10 mol %, and more preferably 0.01 to 2 mol %, to the crystal base material. If the concentration is less than 0.005 mol %, the effect of containing these components cannot be obtained; and if the concentration exceeds 10 mol %, out-of-phase components precipitate, and the luminance lowers markedly.

In the general formulas (1) and (2), the light emitting wavelength can be optionally controlled by adjusting x (0≦x≦1), which is the percentage composition, of the calcium sulfide and/or strontium sulfide represented by (Ca₁₋ₓSrₓ)S, which is the crystal base material, and with increase in the Sr content, the light emitting spectrum shifts toward the short wavelength side, and the blue component increases.

The blue excited yellow fluorescent materials according to the present invention A and B can contain one or more element selected from aluminum-group elements, such as Al and Ga, as a sensitizing agent to improve excitation efficiency. The content thereof is preferably 5 mol % or less. If the content of these elements is more than 5 mol %, large quantities of out-of-phase components precipitate, and the luminance lowers markedly.

The blue excited yellow fluorescent materials according to the present invention A and B can also contain one or more element selected from a group of rare earth elements, such as Sc, Y, La, Gd and Lu, as a sensitizing agent to improve excitation efficiency in the same manner as described above. The content thereof is preferably 5 mol % or less. If the content of these elements is more than 5 mol %, large quantities of out-of-phase components precipitate, and the luminance lowers markedly.

Furthermore, the blue excited yellow fluorescent materials according to the present invention A and B can also contain an alkaline metal element, a monovalent cationic metal such as Ag⁺, or halogen ions, such as Cl⁻, F⁻ and I⁻, as a charge compensation agent. The content thereof is preferably equal to the content of the light emitting center, Ce³⁺, that is, 0.005 to 10 mol %. If the content exceeds 10 mol %, the charge compensation effect is lost, and the luminance is lowered.

Next, an example of a method for manufacturing a blue excited yellow fluorescent material according to the present invention will be described.

In the method for manufacturing a blue excited yellow fluorescent material according to the present invention, the following (I) or (II) is preferably used as materials:

(I) Blue Excited Yellow Fluorescent Material A

Crystal base material: CaS, SrS

Ce salts: CeF₃, Ce₂S₃ and the like

Eu salts: EuF₃, Eu₂S₃ and the like

(II) Blue Excited Yellow Fluorescent Material B

Crystal base material: CaS, SrS

Ce salts: CeF₃, Ce₂S₃ and the like

Mn salts: MnF₂, Mn₂S₃ and the like

By using these materials (I) or (II), the reaction time can be drastically shortened, and oxidation can be suppressed by firing in an inert gas atmosphere, such as hydrogen sulfide or argon.

In the manufacturing method according to the present invention, the above-described materials (I) or (II) are weighed in a predetermined ratio and mixed. The materials are mixed with, for example, a paint shaker, a ball mill or the like using zirconia balls of a diameter of 3 mm as the media for about 90 minutes.

Then, the mixed powder is separated from the media using a screen of 100 μm mesh or finer.

Next, the mixed powder is annealed at 900 to 1180° C. for 1 to 12 hours in an atmosphere of an inert gas, such as hydrogen sulfide gas or argon, to prevent the sulfurization or oxidation. If the annealing temperature is lower than 900° C., the solid phase reaction becomes insufficient; and if it is higher than 1180° C., the composition becomes difficult to control because low-melting-point substances are used in the material, and the substances scatter. If the annealing time is less than 1 hour, it is difficult to obtain reproducibility in the properties of the substance; and if it exceeds 12 hours, a problem of variation of the composition arises because of the scattering of the substance.

After annealing, the mixed powder is pulverized and mixed, and is fired under the same conditions as in annealing so that the sulfurization or oxidation of the entire mixed powder can be prevented. Specifically, firing is performed at 900 to 1180° C. for 1 to 12 hours in an atmosphere of an inert gas, such as hydrogen sulfide gas or argon. If the firing time or firing temperature is beyond the above-described ranges, same problems as in the above-described annealing arise.

The thus manufactured blue excited yellow fluorescent material according the present invention can be not only applied to general illumination, but also expected as the backlight for liquid crystals and the fluorescent material for ELs, FEDs, or CRTs in the field of display devices.

The blue excited yellow fluorescent material described above can be processed into a white light emitting element that exerts high color rendering properties by combining with a light emitting blue light emitting diode, disposing the light emitting diode and the fluorescent material in piles, and using the above-described blue light emitting diode as the excitation light source of the blue excited yellow fluorescent material.

Although examples will be described below, these examples should not be interpreted to limit the present invention.

### EXAMPLE 1

CaS, Ce₂S₃, and EU₂S₃ were used as materials, weighed so that the concentrations of Eu and Ce in the fluorescent material become 0.1 mol % and 0.5 mol %, respectively, and mixed for 90 minutes in a paint shaker using zirconia balls of a diameter of 3 mm as the media. Then, the mixed powder was separated from the media using a screen of 100 μm mesh or finer. Next, the mixed powder was annealed at 1180° C. for 6 hours in a hydrogen sulfide atmosphere, and further fired under entirely the same conditions to obtain a blue excited yellow fluorescent material represented by CaS:Ce, Eu (Example 1).

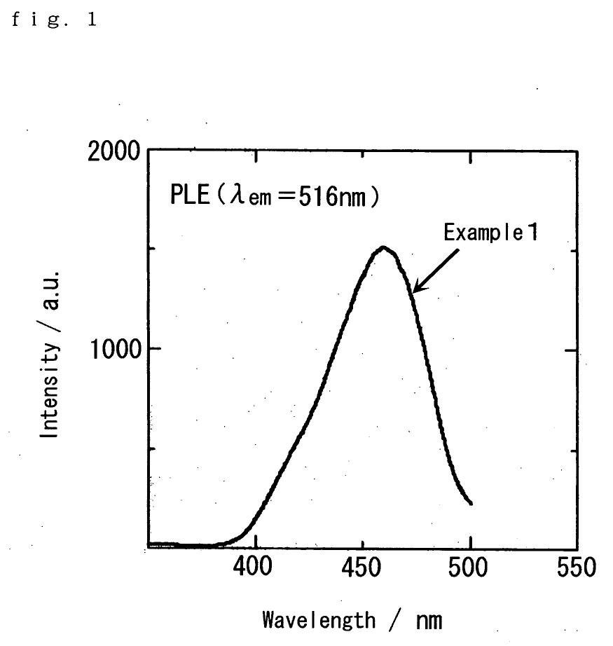

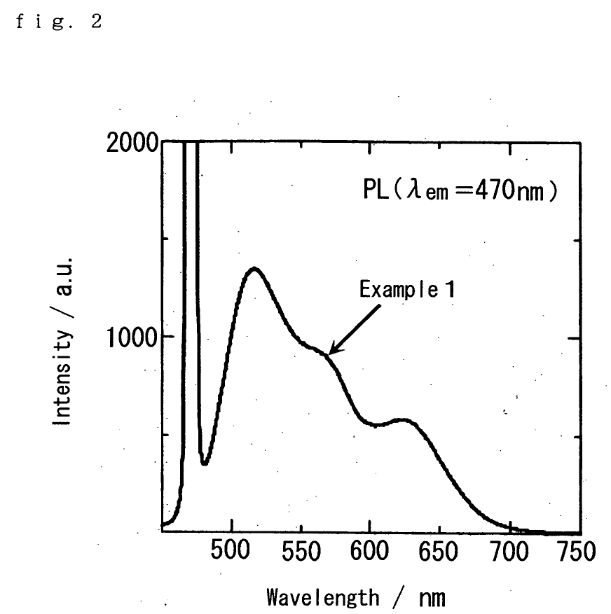

The excitation spectrum of the blue excited yellow fluorescent material is shown in FIG. 1, and the light emission spectrum thereof (excitation wavelength: 470 nm) is shown in FIG. 2. As obviously seen from FIG. 1, the excitation intensity of the yellow fluorescent material is the highest at the vicinity of a wavelength of 470 nm, and is similar to the peak wavelength of the light emission spectrum of a blue LED. Furthermore, as obviously seen from FIG. 2, the fluorescent material has a light emission peak at the vicinity of a wavelength of 520 nm, and exhibits a broad light emission spectrum over a wavelength range between 420 and 680 nm. This wavelength range includes from blue components to red components.

### EXAMPLE 2

CaS, Ce₂S₃, and EU₂S₃ were used as materials, weighed so that the concentrations of Eu and Ce in the fluorescent material became 0.1 mol % and 1.0 mol %, respectively, and mixed for 90 minutes in a paint shaker using zirconia balls of a diameter of 3 mm as the media. Then, the mixed powder was separated from the media using a screen of 100 μm mesh or finer. Next, the mixed powder was annealed at 1180° C. for 6 hours in a hydrogen sulfide atmosphere, and further fired under the same conditions to obtain a blue excited yellow fluorescent material represented by CaS:Ce, Eu (Example 2-1).

A blue excited yellow fluorescent material was obtained in the same manner as in Example 2-1 except that the quantity of Ce₂S₃ was changed so that the Ce concentration in the fluorescent material became 0.5 mol % (Example 2-2).

A blue excited yellow fluorescent material was obtained in the same manner as in Example 2-1 except that Ce₂S₃ was not added (Comparative Example 2-1).

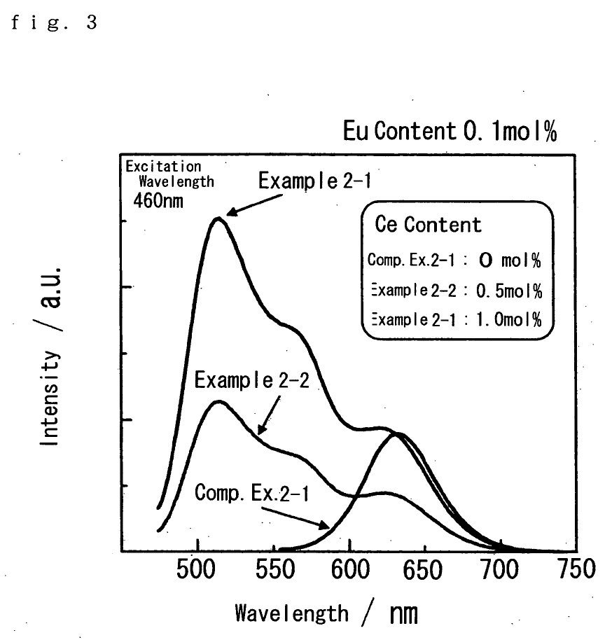

The light emission spectra of these blue excited yellow fluorescent materials (excitation wavelength: 460 nm) were measured. The results are shown in FIG. 3. As is obviously seen from the results in FIG. 3, when Ce concentration rises, the light emission spectrum shifts toward the short wavelength side, and green and yellow light emissions are strengthened.

### EXAMPLE 3

CaS, SrS, Ce₂S₃, and Eu₂S₃were used as materials, weighed so that the concentrations of Eu and Ce in the fluorescent material became 0.1 mol % and 0.5 mol %, respectively in the composition of (Ca_{0.7}Sr_{0.3})S:Eu,Ce, and mixed for 90 minutes in a paint shaker using zirconia balls of a diameter of 3 mm as the media. Then, the mixed powder was separated from the media using a screen of 100 μm mesh or finer. Next, the mixed powder was annealed at 1180° C. for 6 hours in a hydrogen sulfide atmosphere, further pulverized and mixed, and then fired under entirely the same conditions to obtain a blue excited yellow fluorescent material represented by (Ca_{0.7}Sr_{0.3})S:Eu, Ce (Example 3).

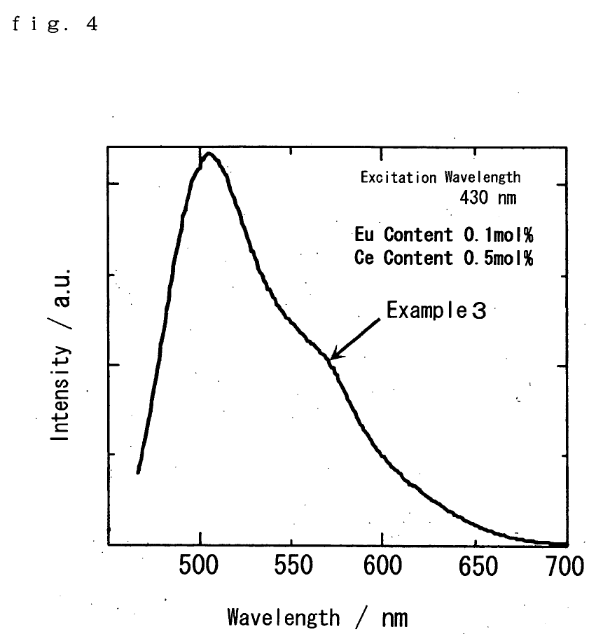

The light emission spectrum of the blue excited yellow fluorescent material (excitation wavelength: 430 nm) was measured. The result is shown in FIG. 4. As is obviously seen from the comparison of Example 3 in FIG. 4 with Example 2-2 in FIG. 3, when Sr is added, the light emission spectrum shifts toward the short wavelength side, and blue components increase. Therefore, the color can be controlled by changing the ratio of Ca and Sr.

### EXAMPLE 4

SrS, Ce₂S₃, and Eu₂S₃ were used as materials, weighed so that the concentrations of Eu and Ce in the fluorescent material became 0.02 mol % and 0.12 mol %, respectively, and mixed for 90 minutes in a paint shaker using zirconia balls of a diameter of 3 mm as the media. Then, the mixed powder was separated from the media using a screen of 100 μm mesh or finer. Next, the mixed powder was annealed at 1180° C. for 6 hours in a hydrogen sulfide atmosphere, pulverized and mixed, and then fired under entirely the same conditions to obtain a blue excited yellow fluorescent material represented by SrS:Eu, Ce (Example 4-1).

A blue excited yellow fluorescent material was obtained in the same manner as in Example 4-1 except that the quantity of Eu₂S₃ was changed so that the Eu concentration in the fluorescent material became 0.04 mol % (Example 4-2).

A blue excited yellow fluorescent material was obtained in the same manner as in Example 4-1 except that the quantity of Eu₂S₃ was changed so that the Eu concentration in the fluorescent material became 0.06 mol % (Example 4-3).

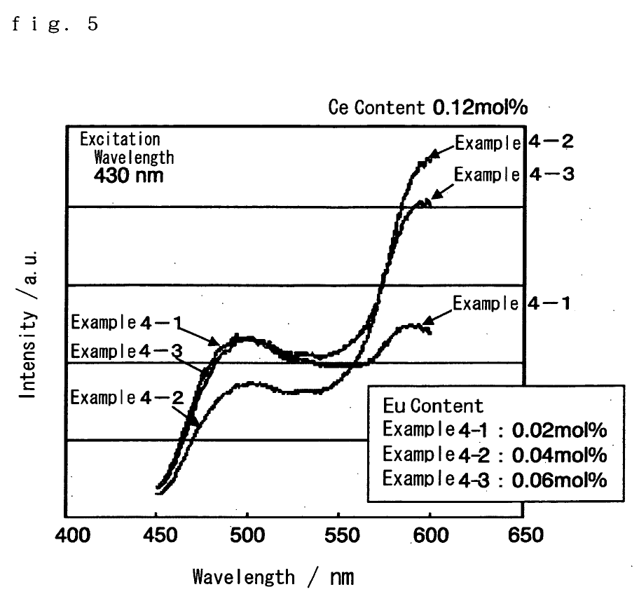

The light emission spectra of these blue excited yellow fluorescent materials (excitation wavelength: 430 nm) were measured. The results are shown in FIG. 5. As is obviously seen from the results in FIG. 5, when Ce concentration is 0.12 mol %, if red components from 570 nm to 580 nm or longer increase, the target white light emission is difficult to obtain when combined with a blue LED; therefore, the Eu concentration is more preferably 0.02 mol % or lower.

### EXAMPLE 5

SrS, Ce₂S₃, and MnF₂ were used as materials, weighed so that the concentrations of Mn and Ce in the fluorescent material became 0.05 mol % and 0.12 mol %, respectively, and mixed for 90 minutes in a paint shaker using zirconia balls of a diameter of 3 mm as the media. Then, the mixed powder was separated from the media using a screen of 100 μm mesh or finer. Next, the mixed powder was annealed at 1180° C. for 6 hours in a hydrogen sulfide atmosphere, further pulverized and mixed, and then fired under entirely the same conditions to obtain a blue excited yellow fluorescent material represented by SrS:Ce, Mn (Example 5-1).

A blue excited yellow fluorescent material was obtained in the same manner as in Example 5-1 except that the quantity of MnF₂ was changed so that the Mn concentration in the fluorescent material became 0.07 mol %, 0.09 mol %, 0.1 mol %, 0.2 mol %, 0.3 mol %, 0.4 mol % and 0.5 mol % (Examples 5-2 to 5-8).

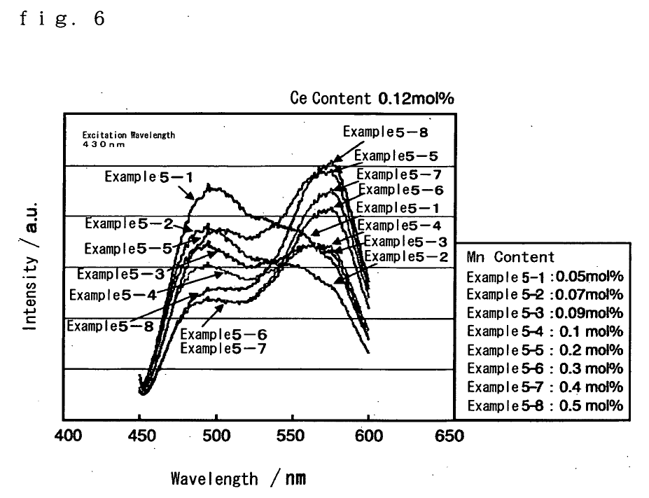

The light emission spectra of these blue excited yellow fluorescent materials (excitation wavelength: 430 nm) were measured. The results are shown in FIG. 6. As is obviously seen from FIG. 6, when Ce concentration is 0.12 mol %, if red components from 570 nm to 580 nm or longer increase, the target white light emission is difficult to obtain when combined with a blue LED; therefore, the Mn concentration is more preferably 0.1 mol % or lower.

The blue excited yellow fluorescent material according to the present invention has excellent color rendering properties by combining with a blue light emitting element, because it includes a plenty of green components and red components in the light emitting spectrum compared with heretofore proposed fluorescent material, such as cerium-activated garnet fluorescent material (Y₃Al₅O₁₂:Ce) and it is highly applicable to general illuminations, because it displays white light similar to natural light (sunlight). In particular, recolor rendering properties, which have been seen as a problem, are markedly improved, and the blue excited yellow fluorescent material is not only effective for illuminations used in the product displaying shelves in which fresh food products are displayed in supermarkets or convenience stores, and dining tables in restaurants and homes, or illuminations mounted to medical endoscopes, but also expected as a fluorescent materials for the backlight of liquid crystal displays, ELs, FEDs, or CRTs in the fields of display devices.

1. A blue excited yellow fluorescent material comprising an alkaline earth metal sulfide as a crystal base material, the fluorescent material activated by Ce³⁺ and Eu²⁺.

2. The blue excited yellow fluorescent material according to claim 1 represented by the following general formula (1):
(Ca₁₋ₓSrₓ)S:Ce, Eu (1)
wherein 0≦x≦1.

3. The blue excited yellow fluorescent material according to claim 1, wherein the concentration of the Ce³⁺ and Eu²⁺ is 0.005 to 10 mol % based on the crystal base material.

4. A blue excited yellow fluorescent material comprising an alkaline earth metal sulfide as a crystal base material, the fluorescent material activated by Ce³⁺ and Mn²⁺.

5. The blue excited yellow fluorescent material according to claim 4 represented by the following general formula (2):
(Ca₁₋ₓSrₓ)S:Ce, Mn (2)
wherein 0≦x≦1.

6. The blue excited yellow fluorescent material according to claim 4, wherein the concentration of the Ce³⁺ and Mn²⁺ is 0.005 to 10 mol % based on the crystal base material.

7. A white light emitting element comprising a blue light emitting diode and a blue excited yellow fluorescent material according to claim 1, wherein the blue light emitting diode is used as an excitation light source for the blue excited yellow fluorescent material.
